(19) United States
(12) Patent Application Publication
(10) Pub. No.: US 2003/0230850 A1
(43) Pub. Date: Dec. 18, 2003

(54) Device for sealing the gap between a stationary housing and rotating shaft

(75) Inventors: Didier Bruyere, Chalindrey (FR); Dominique Lutaud, Orbigny au Mont (FR)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 10/457,299

(22) Filed: Jun. 9, 2003

(30) Foreign Application Priority Data
Jun. 11, 2002 (DE) DE102 259 59.3-52

(51) Int. Cl. F16J 15/32

(52) U.S. Cl. 277/349

(57) ABSTRACT

A device for sealing the gap between a stationary housing and a rotating shaft includes a radial packing ring in a stationary mount in the housing, the packing ring having a sealing lip made of a polymer material that comes in contact with the shaft under an elastic prestress, and a pulse wheel is mounted upstream from the radial packing ring in the direction of the outside air, rotates with the shaft and has a pulse generator surrounding the shaft at a radial distance, and a sensor in a stationary mount for detecting rotational movements of the pulse wheel, the pulse generator (7) being formed by a cylindrical sleeve (24) having magnetic poles (8) facing radially outward or being composed of a generator wheel (13) having teeth (14) and spaces between the teeth on the outer circumference, and the sealing lip (9) is in the form of a ring disk due to the manufacturing method, and in the area of its inner circumference it becomes wider from the direction of the pulse wheel (7), its inner circumference engaging in the gap formed by the distance between the sleeve (24) and the shaft (3).

Priority to German Patent Application No. 102 25 959.3-52, filed Jun. 11, 2002 and hereby incorporated by reference herein, is claimed.

### BACKGROUND INFORMATION

The present invention relates to a device for sealing the gap between a stationary housing and a rotating shaft, including a radial packing ring in a stationary mount in the housing, the packing ring having a sealing lip made of a polymer material that comes in contact with the shaft under an elastic prestress, and including a pulse wheel which is mounted upstream from the radial packing ring in the direction of the outside air, rotates with the shaft and has a pulse generator surrounding the shaft at a radial distance, and including a sensor in a stationary mount for detecting rotational movements of the pulse wheel.

European Patent 726 468 B1, for example, describes such a device in which the pulse generator rotates with the shaft and an additional pickup is provided for the pulse signals. However, the known device requires a relatively large installation space and cannot be used if this space is not available. This is the case at the rear end of the crankshaft, for example, because space there is very limited due to the flywheel.

### SUMMARY OF THE INVENTION

An object of the present invention is to design a device for sealing the gap between a stationary housing and a rotating shaft so that it may be used in radial and/or axial directions with an extremely small installation space. The sensor should be readily accessible, which is very important in the event of repairs. This device should be inexpensive to manufacture and simple to install while also having a long service life.

The present invention provides a device for sealing the gap between a stationary housing and a rotating shaft characterized by the fact that the pulse generator is formed by a cylindrical sleeve having magnetic poles facing radially outward or is composed of a generator wheel having teeth and spaces between the teeth on the outer circumference, that the sealing lip is in the form of a circular ring disk due to the manufacturing method, and in the area of its inner circumference it becomes wider from the direction of the pulse wheel, its inner circumference engaging in the gap formed by the distance between the sleeve and the shaft. A device having such a design may be mounted on the rear end of the crankshaft of a reciprocating piston engine, for example. This location is advantageous in particular in determination of the running smoothness of the crankshaft and for detection of misfiring.

The ring disk is provided with hydrodynamic recirculation elements for fluid leakage at least in the section adjacent to the shaft. When it comes in contact with the shaft, the disk is converted into a type of gasket which surrounds the shaft concentrically. The recirculation elements may run in a helical pattern from the free end of the gasket to the tie-down area of the gasket at the greatest extent. In addition, the gasket may be blocked by an interruption in the twist in the area where it contacts the shaft. The cross section of the recesses, which function as recirculation elements, may be U-shaped, V-shaped or of a similar design. A single trhead recesses or multiple thread recesses may be provided.

The disk is preferably made of PTFE or rubber, but PTFE compounds, elastomers or crosslinkable thermoplastics may also be used.

The entire device may be designed as a modular unit composed of the radial packing ring, the pulse wheel and the sensor.

A space-saving design of the device is achieved in particular when the pulse wheel has a mounting flange which extends radially and is clamped between an end face of a crankshaft and a flywheel on an internal combustion engine when used as intended. The pulse wheel may be bolted to the end face of the crankshaft via the mounting flange.

The sensor is preferably situated on the ambient side of the sealing site. This is cost efficient and requires less space.

### BRIEF DESCRIPTION OF THE DRAWING

The invention is explained in greater detail below on the basis of several exemplary embodiments illustrated in the drawing, in which:

FIG. 1 shows a longitudinal section through the device having a pulse wheel, a sensor and a gasket,

FIG. 2 shows the device having a gasket of a different design, also shown in a longitudinal section,

FIG. 3 shows a longitudinal section of the device having a generator wheel and a gasket mounted in an adhesive part,

FIG. 4 shows a device like that in FIG. 2, having a generator wheel and a gasket mounted on the medium side, and

FIG. 5 shows the device having a generator wheel which is pressed onto the shaft and functions as a bearing surface for the gasket.

### DETAILED DESCRIPTION

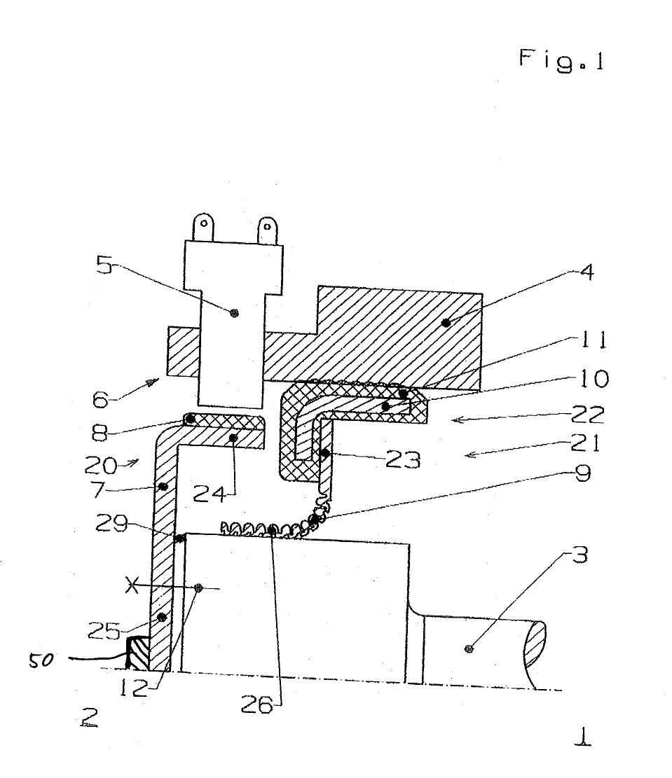

A first embodiment of the present invention with device 20 shown in FIG. 1 includes essentially radial packing ring 21, multi-pole wheel 7 and sensor 5. Radial packing ring 21 has a gasket 9, which is made of a polymer material and is in turn secured at its outer edge 23 radially on mount 22. Mount 22 includes reinforcing ring 10 made of metal surrounded by a sheathing 11 of a polymer material. Gasket 9 is made of PTFE in a trumpet-shaped design. On its straight section 26, gasket 9 is in contact with shaft 3. Mount 22 is pressed into bore 6 in housing 4 in a stationary position. Pulse generator 7 is composed of a cylindrical sleeve 24, which is provided with magnetic poles 8 pointing radially outward. In addition, sleeve 24 has a mounting flange 25, which extends in the radial direction and by which pulse wheel 7 is bolted to the end face of crankshaft 3. A flywheel 50 (shown schematically) may also be bolted to the crankshaft at the same time. Sensor 5 is mounted on housing 4 and is used in a known way to pick up the various measurement data. Sensor 5 is opposite the magnetized polymer layer on the outer circumference of multi-pole wheel 7 and protrudes into housing bore 6. The configuration of sensor 5, multi-pole wheel 7 and gasket 9 is such that sensor 5 is radially above magnetized polymer layer 8 of multi-pole wheel 7 and section 26 of gasket 9, which is in contact with shaft 3. This minimizes the axial extent of the entire device. The medium to be sealed is in space 1, while space 2 contains the ambient air.

Section 26 may be helically shaped, so that fluid may be transferred, and thus the protrusions on section 26 may define hydrodynamic recirculation elements.

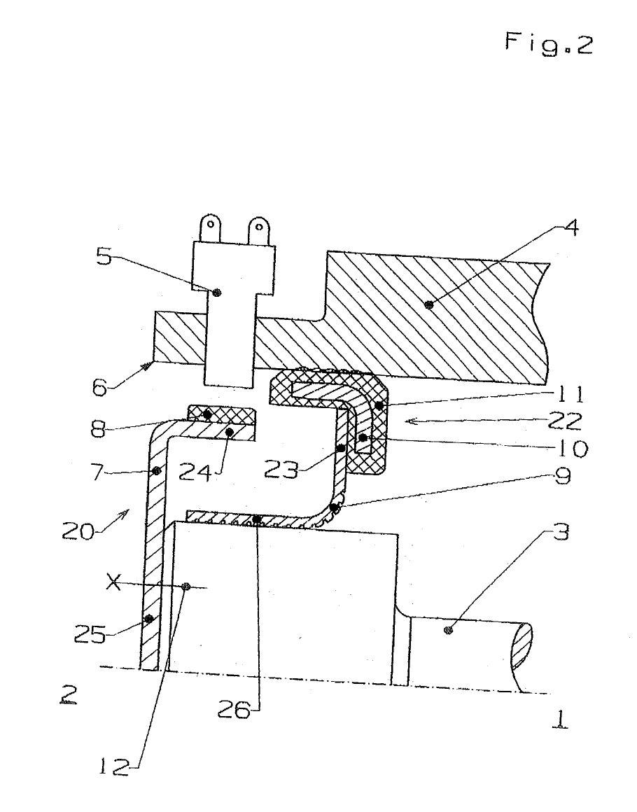

FIG. 2 shows another embodiment of device 20 in a longitudinal section, the essential parts of which correspond to the embodiment according to FIG. 1, the difference being that mount 22 is inserted in an inverted position, and fastening part 23 of gasket 9 is oriented toward ambient side 2.

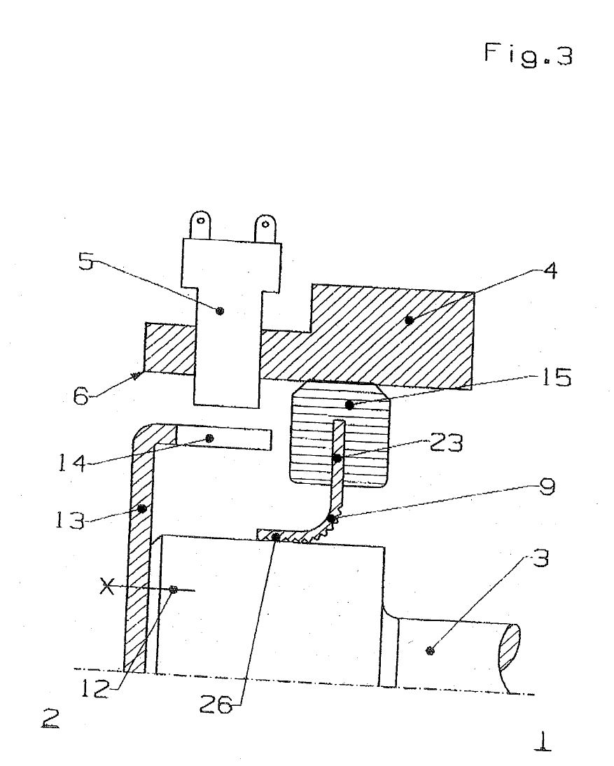

FIG. 3 shows an embodiment in which a generator wheel 13 is used, having teeth 14 alternating with spaces on its outer circumference. In addition, gasket 9 with its fastening part 23 is mounted in an adhesive part 15 made of plastic. This adhesive part is pressed into bore 6 of housing 5.

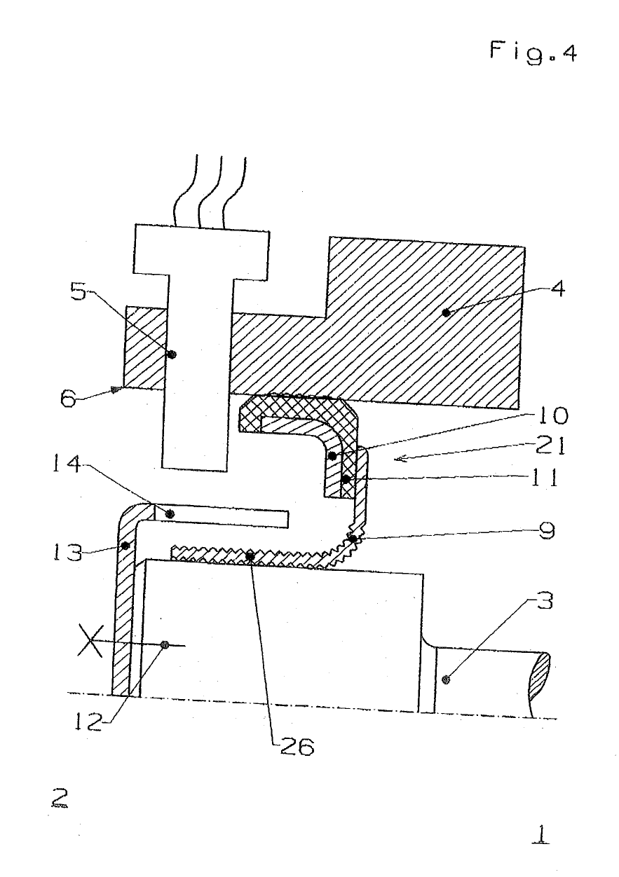

FIG. 4 shows a further embodiment of the design of the packing ring and the attachment of gasket 9 to the same. Packing ring 21 in this case is composed of reinforcement ring 10, which is provided with a sheathing 11 of a polymer material only on its outer side facing housing 4 and gasket 9. In this embodiment, a generator wheel 13 is also provided with teeth 14.

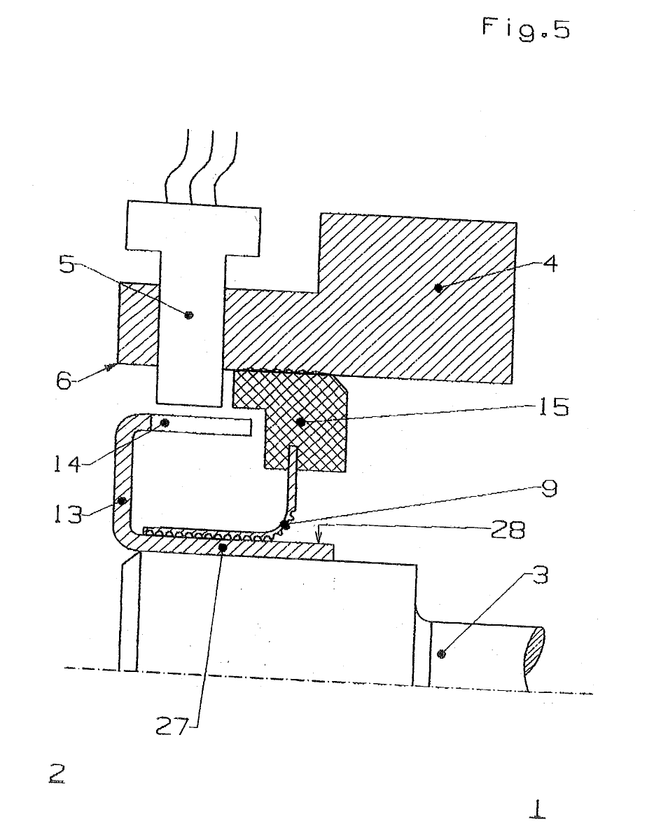

FIG. 5 shows an embodiment in which gasket 9 is mounted in housing 4 using plastic adhesive part 15. Generator wheel 13, however, is provided with attachment sleeve 27 which is used for attaching generator wheel 13 onto shaft 3 and simultaneously as a running face for gasket 9 with its side 28 facing away from shaft 3.

The device according to the present invention may be given an extremely compact design. Gasket 9 may, for example, be designed as a disk with a thickness of just 1 mm and it is provided with its trumpet shape by sliding onto shaft 3, while shaft 3 is to be provided with a chamfered edge 29 (FIG. 1) on its outer end.

What is claimed is:

1. A device for sealing the gap between a stationary housing and a rotating shaft, the device comprising:
a radial packing ring mounted stationarily with respect to the housing, the packing ring having a sealing lip made of a polymer material, the sealing lip contacting the shaft under an elastic prestress,
a pulse wheel mounted upstream from the radial packing ring in a direction of an end of the shaft, the pulse wheel rotating with the shaft and having a pulse generator surrounding the shaft at a radial distance, the pulse generator including a cylindrical sleeve having magnetic poles facing radially outward or a generator wheel having teeth and spaces between the teeth on an outer circumference, and
a sensor mounted stationarily with respect to the housing for detecting rotational movements of the pulse wheel,
the sealing lip being manufactured as a ring disk, the ring disk having an inner circumference widening from a direction of the pulse wheel, the ring disk engaging in the gap formed by the radial distance between the pulse generator and the shaft.

2. The device as recited in claim 1 wherein the ring disk has hydrodynamic recirculation elements for fluid transfer, at least in a section adjacent to the shaft.

3. The device as recited in claim 1 wherein the ring disk is made of PTFE, a PTFE compound or rubber.

4. The device as recited in claim 1 wherein the radial packing ring, the pulse wheel and the sensor are a modular unit.

5. The device as recited in claim 1 wherein the pulse wheel has a mounting flange extending radially and clamped between an end face of the shaft and a flywheel of an internal combustion engine.

6. The device as recited in claim 1 wherein the sensor is situated opposite a sealing side of the sealing lip.

7. The device as recited in claim 1 wherein sensor is situated radially about the magnetic poles of the pulse generator or the generator wheel, the magnetic poles or the generator hweel being situated radially about at least part of a section of the ring disk.
